(19) United States
(12) Patent Application Publication
(10) Pub. No.: US 2007/0217892 A1
(43) Pub. Date: Sep. 20, 2007

(54) Reconfigurable power handling device

(76) Inventor: Gregory James Newell, Santa Monica, CA (US)

Correspondence Address: John R. Flanagan, P. O. Box 2629, Eugene, OR, 97402, US

(21) Appl. No.: 10/609,276

(22) Filed: Jun. 27, 2003

(51) Int. Cl. B23Q 5/22

(52) U.S. Cl. 414/14

(57) ABSTRACT

A power handling device having a chassis supporting at least two rolling elements, a handle shaft mounting to the chassis, a motor for driving at least one of said rolling elements, and a power supply for energizing the motor. The power handling device is characterized by a Non-Interference Envelope (NIE) defined by straight lines intersecting outermost points of tangency on at least two of the rolling elements. To enable reconfiguration and reorientation of the power handling device, the motor and other propulsion related components lie within the NIE. In another embodiment of the invention, at least three rolling elements are arranged to define a substantially triangular profile and a means is provided for reconfiguring said chassis to enable support by at least two pairs of rolling elements. This embodiment greatly expands the functionality and variety of applications. In yet another embodiment of the invention, the power handling device includes a pivotable fitting to enable use in two operational modes, one to roll an object and another to push/pull an object.

### TECHNICAL FIELD

This invention relates to power handling devices for manipulating heavy loads, and, more particularly, to a new and useful handling device which is, inter alia, compact, versatile, reconfigurable/modular, aesthetically pleasing, and comprises a minimum number of component parts for reduced complexity and improved reliability.

### BACKGROUND OF THE INVENTION

In the past two decades greater emphasis has been placed on employee safety and lost productivity due to injuries in the workplace. In nearly every Fortune 500 Corporation, programs and special tools are employed to minimize injuries due to poor use of body mechanics resulting in muscle strains, joint injuries, torn ligaments and tendons etc. Oftentimes, equipment, machinery and tools are analyzed and modified for improved ergonomics, i.e., designed to cooperate/complement the natural strengths, leverage points and movements of the human body.

Another trend tending to conflict with the above safety issues are the packaging and production of larger, heavier raw materials/material containers which require special handling. That is, manufacturers of such goods as paper, wire and cable, deliver such materials in bulk for economy of warehouse/stocking space and, of course, greater revenues. For example, a roll of raw paper material which may have previously been delivered in one ton rolls may now be sold in significantly larger quantities, e.g., three ton rolls, to lower the cost to consumers while improving margins for the manufacturer.

The size and weight of such packaged goods/products presents challenges for those responsible for their shipment, storage and use, especially when operating in confined work/warehouse environments. While gross movement and handling of such heavy, multi-ton goods/products is readily achieved by conventional lifting/towing devices, e.g., forklifts, grabbers etc., there are commonly areas of the workplace that require movement or more precise manipulation of these goods/products without the assistance of conventional materials handling devices. For example, where drums or rolls need to be moved short distances into or out of unwind stands, rewind stands or other secondary processing stages, confined work areas renders automated methods inappropriate.

In the past, it was considered acceptable for a worker or workmen to use their body strength, i.e., “brute force”, to manipulate the object into its storage space or dispensing position. At the current time, however, employees are urged to use caution and/or directed not to use body strength to manipulate heavy objects, but to seek other methods and/or use other tools to move/position such objects. This is especially true due to the increasing tendency for the weights requiring movement being larger/heavier and cycle times increasing in line with increased productivity pressures.

Only recently, i.e., within the past 10-15 years, have sufficiently compact, powered devices become available with sufficient mechanical advantage (i.e. power) to manipulate multi-ton objects in the workplace. U.S. Pat. No. 4,582,154 discloses a drive device for manipulating large multi-ton cylindrical objects such as large rolls of paper material/stock or large reels of electrical cable. The drive device is produced under the trade name “EasyMover” and comprises a plurality of rolling elements in combination with a drive roller which, by contacting the cylindrical surface of the object and the floor beneath, causes the object to rotate and move in a desired direction. More specifically, and referring to FIG. 1a, the drive device 200 includes a support roller 202, intermediate roller 204 and aft wheels 206 which are mounted to a chassis 208. The rolling elements 202, 204 and 206 are, furthermore, spaced-apart and essentially co-planar A drive roller 210 is disposed above and slightly aft of the support roller 202 to define an acute angle or “wedge-shaped” nose end. Additionally, a pneumatically powered high torque motor 212 is disposed aft of the drive roller 210 and in a substantially horizontal plane relative thereto. Therefore, in the profile view shown in FIG. 1b, the drive device 200 defines a substantially trapezoidal shape having a base 220 defined by a line intersecting tangency points on the forward roller 202 and the aft wheels 206. The drive roller 210 and exterior surface of the motor 212 similarly define the converging sides 222 and top 224 of the polygon.

Referring again to FIG. 1a, torque is driven from the motor 212 to the drive roller 210 by means of one or more horizontal chain links 230 which engage sprockets 216 disposed on the output drive shaft of the motor 212 and input drive shaft of the drive roller 210. Furthermore, a passageway is provided for delivering pressurized air to the motor 212 via tube segments and fittings 234 which are in fluid communication with a tubular handle shaft 236.

Additionally, the EasyMover device described above requires external power to maintain a compact design envelop. However, the requirement for an external energy source requires that the unit be “tethered” in the sense that a compressed air line must remain connected to the device while in operation. In operation, the device 200 is wedged under a cylindrically-shaped object 240, i.e., between the cylindrical surface thereof and the floor beneath. When positioned in this manner, the drive roller 210 makes circumferential contact with the support roller 202 to drive the unit and, therefore, the object/load in a forward direction.

Prior to such positioning, prepositioning of the device 200 is necessary. Prepositioning is achieved by rolling the unit on the intermediate roller 204 and/or the aft wheels 206 with the support roller 202 being slightly raised to permit free-wheeling of the device while prepositioning. It will be appreciated that inasmuch as the support roller 202 is in frictional engagement with the drive roller 210 (which does not rotate in an unpowered condition), the support roller 202 must be raised slightly to allow the device 200 to roll freely.

Yet another feature of the device 200, and referring to FIGS. 1c-1e, includes a circumferential seal 250 disposed between the handle shaft 236 and the chassis 208 for permitting rotation about a substantially vertical axis VA (shown in FIG. 1d). Furthermore, the handle shaft 236 contains a right angle bend so as to position the shaft 236 on either side of the chassis 208 or center the shaft 236 relative thereto (as seen in FIG. 1e, but only when maneuvering the unpowered unit into position). This feature permits operation of the drive device 200 from either the right or left hand side of the device.

While the device 200 incorporates many features which continue to be used today, i.e., pneumatically driven motor, compact design envelope, etc., the device has several shortcomings and disadvantages.

Firstly, due to the spatial positioning and number of elements, e.g., forward roller, drive roller, motor etc., the drive device is longer and heavier than would be ideally preferred. Exacerbating the lack of maneuverability is the use of the intermediate roller 204 in combination with the aft wheels 206 to preposition the device. That is, the cylindrical configuration of the intermediate roller 204 requires that the operator slide or drag the device to change direction, e.g., turn right to left, into a desired position. Moreover, the device cannot be tilted upward about its aft wheels 206 to facilitate mobility due to the small diameter of the aft wheels in combination with the length of the unit. One may analogize the manipulation of the device to parallel parking a multi-axle tractor trailer into a confined space. Furthermore, the length and weight of the device effects a forward center of gravity (generates a large moment arm) which cannot be easily lifted.

Secondly, the device comprises a multiplicity of components which increases complexity and manufacturing costs, and more importantly, decreases the reliability of the device. These components include the chain-link drive which is subject to failure and requires periodic maintenance, and a rotating air fitting which is typically loaded during lifting/prepositioning, but is not intended for such application. Finally, the device is essentially uni-directional and has limited application, i.e., can only function to push an object. Other functions such as pulling an object or changing direction, require other or additional dedicated devices.

A need therefore exists for a handling device which is compact in size, possesses fewer component parts, provides enhanced reliability, and is reconfigurable/modular for improved functionality/use.

### SUMMARY OF THE INVENTION

It is an object of the present invention to provide a power handling device for manipulating heavy loads which is compact and versatile for use in various industrial applications.

It is another object of the present invention to provide such a power handling device which is reconfigurable for rolling cylindrical objects, forwardly and rearwardly, while additionally being able to push/pull objects having a variety of shapes/sizes.

It is yet another object of the present invention to provide a power handling device which may be used in a variety of orientations, i.e., right-hand, left-hand etc., to permit manipulation from either side of a load.

It is still another object of the present invention to provide such a power handling device which is modular in design to allow substitution of other component parts for permitting commonality of parts thereby decreasing costs.

It is yet another object of the present invention to provide a power handling device which is aesthetically pleasing for improved appeal in the marketplace.

These and other objects are achieved by a power handling device having a chassis supporting at least two rolling elements, a handle shaft mounting to the chassis, a motor for driving at least one of said rolling elements, and a power supply for energizing the motor. In the broadest embodiment of the invention, the power handling device is characterized by a Non-Interference Envelope (NIE) defined by straight lines intersecting outermost points of tangency on at least two of the rolling elements. To enable reconfiguration and reorientation of the power handling device, the motor and other propulsion related components are disposed internally of the NIE.

In another embodiment of the invention, at least three rolling elements are arranged to define a substantially triangular profile and a means is provided for reconfiguring the chassis to enable support by at least two pairs of rolling elements. In yet another embodiment of the invention, the power handling device includes a pivotable fitting to enable use in two operational modes, one to roll an object and another to push/pull an object.

In yet another embodiment of the invention, the power handling device comprises two separable sections, i.e., a forward propulsion section and an aft handling section, to facilitate reconfiguration and/or permit interchangeability of components. More specifically, to perform the aforementioned operations, in addition to yet others, it will be necessary to vary the position, e.g., angular orientation, of the handle shaft relative to the chassis. The forward propulsion and aft handling sections are detachably mounted via a pair of identically configured lap joints capable of reversibly mounting the units to achieve the desired handle shaft orientation or configuration. Alternatively, the mounting arrangement also facilitates the interchangeability of units having different or additional functionality.

### BRIEF DESCRIPTION OF THE DRAWINGS

A more complete understanding of the present invention and the attendant features and advantages thereof may be had by reference to the following detailed description of the invention when considered in conjunction with the following drawings wherein:

FIG. 1a is a profile view of a prior art drive device for manipulating a heavy cylindrical object.

FIG. 1b is the same profile view of the drive device illustrated in FIG. 1a emphasizing the geometric shape and size of the prior art device,

FIG. 1c depicts a view of the prior art drive device taken along line 1c-1c of FIG. 1a.

FIGS. 1d and 1e depict the same view of the prior art drive device as that shown in FIG. 1c wherein the handle shaft of the drive device is shown in two additional positions.

FIG. 2a is a front view of the power handling device (excluding the handle and handle shaft thereof) according to the present invention in a common operating configuration and orientation.

FIG. 2b is a profile view of the power handling device according to the present invention in the operating configuration shown in FIG. 2a.

FIG. 3 is an exploded view of the power handling device according to the present invention including a chassis, a forward roller, drive roller and aft pair wheels which, collectively, are supported for rotation by the chassis, and a motor for delivering torque to the drive roller.

FIG. 4 is a cross-sectional view taken substantially along line 4-4 of FIG. 2b which is a view taken along a plane of intersecting the drive roller and aft pair of wheels.

FIG. 5 is a schematic view of the power handling device illustrating an important feature of the invention wherein a Non-Interference Envelope (NIE) is defined for enabling the power handling device to be supported by the aft pair of wheels and at least one of the other remaining rolling elements.

FIG. 6 depicts an exploded view of an alternate embodiment of the aft handling section wherein the handle shaft is pivotally mounted to the chassis about the rotational axis of the aft wheels and, further includes a means for repositioning the angular orientation of the handle shaft relative to the chassis.

FIG. 7 is a sectional view of the aft handling section shown in FIG. 6 (assembled) along a horizontal plane and collinearly aligned with the rotational axis of the aft wheels.

FIG. 8 depicts an alternate embodiment of the inventive power handling device (perspective view) wherein the device has been rotated about the aft wheels such that the drive roller provides the motive force relative to the floor and the forward roller has been replaced by a push/pull plate.

FIG. 9 depicts another embodiment of the inventive power handling device (perspective view) wherein forward facing forks are pivotally mounted to an upper portion of the chassis to positively engage an object while being moved/manipulated.

FIGS. 10a-10k depict various orientations/configurations which may be employed to manipulate loads in a variety of applications.

### BEST MODE FOR CARRYING OUT THE INVENTION

The invention described herein is best illustrated by reference to a particularly relevant application which best demonstrates its utility and advantages. More specifically, the power handling device of the present invention will be described in the context of the movement and manipulation of large, multi-ton cylindrical objects/raw materials such as those used in the paper or wire cable industries. However, it will readily be appreciated that the power handling device may be employed in any application wherein the movement/manipulation of heavy objects is required. The power handling device of the present invention will first be described in the context of a pneumatic power source and briefly described in the context of an electrical power source. With respect to the latter, the electrical power source is integral with the device thereby enabling portable, self-powered operation.

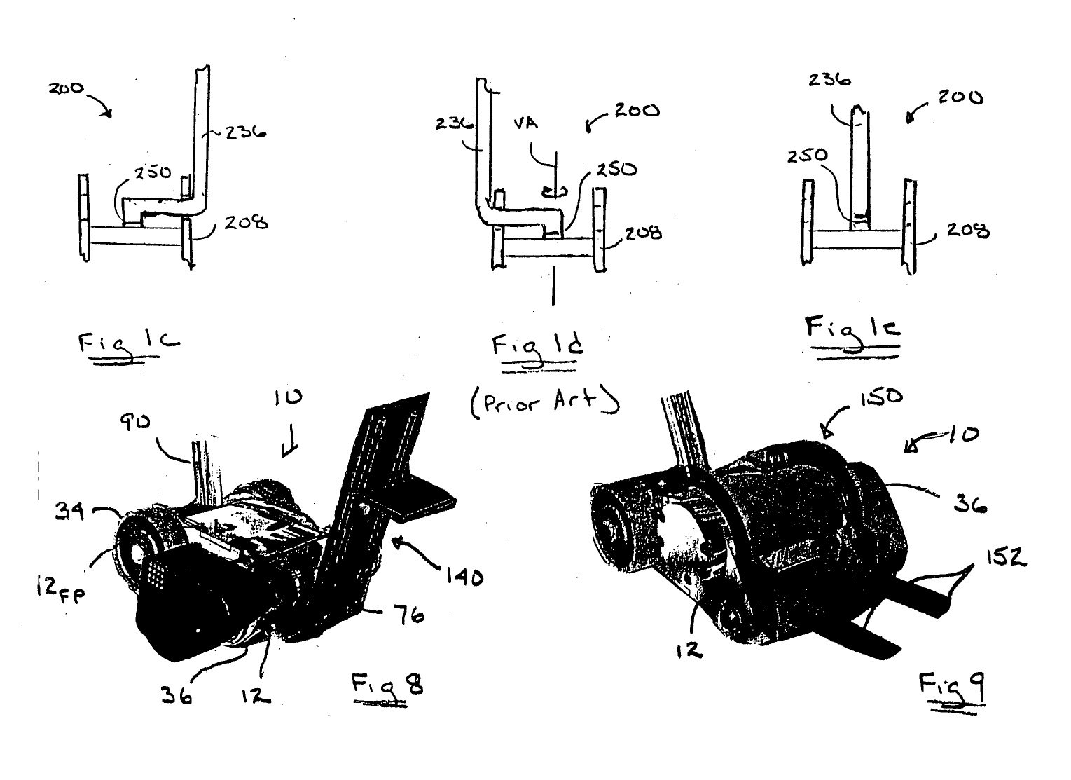

In FIGS. 2a and 2b, the power handling device 10 of the present invention includes a chassis 12 adapted for accepting and rotationally mounting two or more rolling elements 30, a motor 50 for driving at least one of the rolling elements 30, and a handle shaft 90 mounting to the chassis 12. The integration and function of each will be described in the subsequent paragraphs.

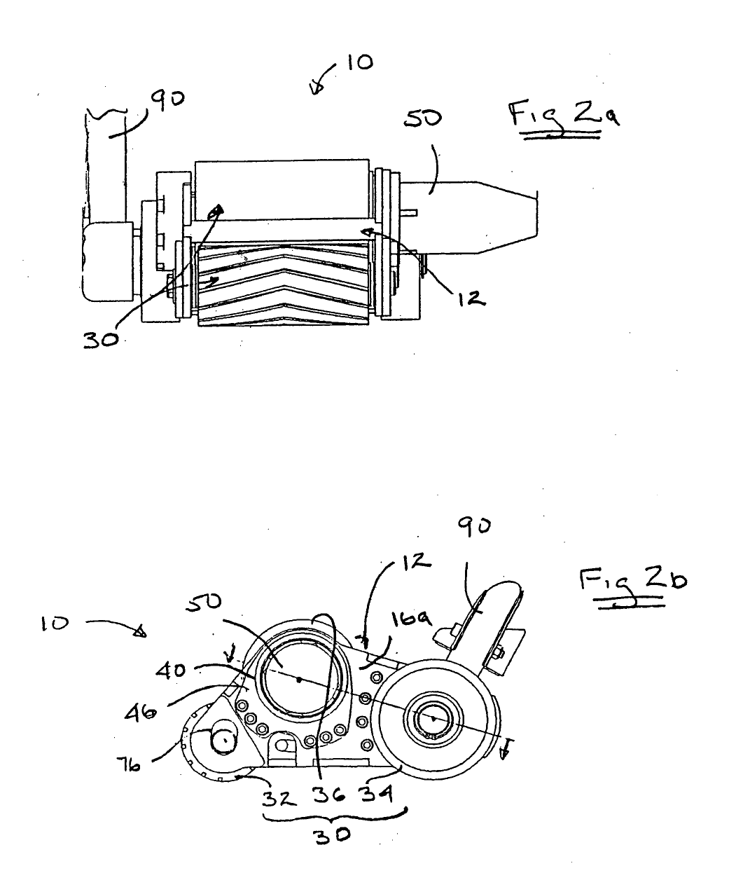

In the preferred embodiment, and referring to FIGS. 2b and 3, the chassis 12 comprises first and second sideplates 16a, 16b structurally interconnected by two or more cross members 18, although three cross members 18a, 18b and 18c are illustrated in the described embodiment. While the chassis 12 may be constructed as a single unit, in the preferred embodiment, the chassis 12 is separated or bifurcated to form forward and aft portions 12a and 12b, respectively. The forward portion 12a in combination with other elements functioning to propel the device 10 is referred to as the forward propulsion section 12_{FP}. Similarly, the aft portion 12b in combination with elements relating to the handling/positioning of the device 10 is referred to as the aft handling section 12_{AH}. The forward propulsion section 12_{FP} may be “reversed” or rotated 180 degrees relative to a longitudinal axis such that the power handling device 10 may be supported by either one of potentially two rolling elements 30. Furthermore, various components may be substituted or added to the forward propulsion section 12_{FP} to provide other or different operational capabilities. Moreover, the rolling elements 30 may be replaced as may be required for routine maintenance.

The aft handling section 12_{AH}, on the other hand, does not employ substitutable components for performing different functions nor does it require routine replacement of parts, for maintenance purposes. Although, many different embodiments of the aft handling section 12_{AH}, are envisioned, (e.g., fixed handle or handle accommodating pneumatic or electric power delivery etc.) as will be described in greater detail below.

In one of the preferred embodiments, the chassis 12 is adapted to support three rolling elements 30 comprising a forward support roller 32 (sometimes referred to as simply the “forward roller” when not shown in an embodiment requiring “support”), a pair of aft wheels 34, and a drive roller 36 interposed between the forward support roller 32 and aft wheels 34. In the context used herein, the term “rolling element” means any object having a circular cross-section in at least one plane orthogonal to its rotational axis. Consequently, cylindrical rollers, wheels or other functional equivalents are intended to fall within the meaning of the term rolling element. Furthermore, in one of the primary configurations or applications of the power-handling device 10, the drive roller 36 is elevated relative to the other rolling elements 32, 34 to define a triangular profile geometry. As such, the drive roller 36 is disposed at the apex of the triangle. Moreover, the rotational axes 32A, 34A and 36A (referenced in FIG. 3) of the respective rolling elements 32, 34, 36 are substantially parallel to each other and orthogonal to the direction of forward motion.

The chassis 12 also includes several detachable elements which provide structural support for the rolling elements yet may be removed to facilitate assembly/disassembly. More specifically, the chassis 12 also includes a cylindrical support 40 mounted to one of the sideplates 16a and an end cap 42 (shown only in FIG. 3) mounting to the other sideplate 16b.

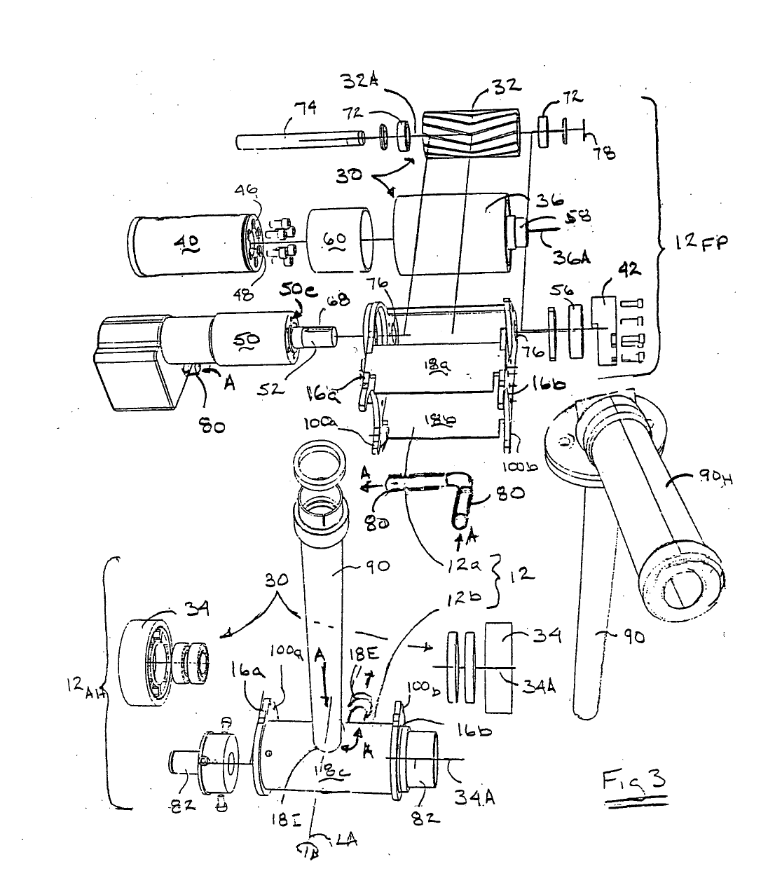

Referring to FIGS. 2b-4, the cylindrical support 40 includes a first outwardly projecting flange 44 (see FIG. 2b) for mounting to one of the sideplate 16a and an inwardly projecting flange 46 (FIGS. 3 and 4 ) for mounting to an end portion of the motor 50. Consequently, the motor 50 is disposed internally of and held stationary by the cylindrical support 40. The inwardly projecting flange 46 of the cylindrical support 40 also defines an aperture 48 for accepting an output drive shaft 52 of the motor 50 which extends through the aperture 48. It should be noted that the flanges 44, 46 may or may not be integral with the central cylindrical element, but may be individual parts of the whole cylindrical support 40.

The drive roller 36 comprises a cylindrical body 54 which is disposed over and supported by the cylindrical support 40 at one end thereof and is supported at the other end by a journal bearing 56. The journal bearing 56 accepts a stub axle 58 of the cylindrical body 54 and is supported within the chassis-mounted end cap 42. In the preferred embodiment, an oil impregnated brass sleeve 60 is disposed between the drive roller 36 and the cylindrical support 40 to provide a low friction bearing interface therebetween.

More specifically, the cylindrical body 54 of the drive roller 36 defines a first end 62 which is open for accepting the cylindrical support 40 and a second end 64 which is configured (e.g., necked-down) to form the stub axle 58 as an integral element of the cylindrical body 54. Additionally, the second end 64 is adapted for receiving the output drive shaft 52 of the motor 50 and for transferring torque from the motor 50 to the drive roller 36. In the preferred embodiment, a keyway (not shown) is formed internally of the stub axle 58 for receiving a key 68 formed on the exterior of the output drive shaft 52. While the embodiment shown describes a keyed connection for transferring torque, it will be appreciated that the invention envisions any of a variety of means for transferring torque from the output drive shaft 52 to the drive roller 36.

The drive roller 36, therefore, circumscribes or envelops the output drive shaft 52 of the motor 50 in addition to a significant portion of the motor itself. Furthermore, the drive roller 36 is coaxial with the output drive shaft 52 and driven directly thereby. Finally, the stub axle 58 of the drive roller 36 dually serves to support the drive roller 36 and output drive shaft 52 within the journal bearing 56.

In the preferred embodiment, and still referring to FIGS. 3 and 4, a material 70 having a high frictional coefficient is disposed upon the exterior surface of the cylindrical body 52 of the drive roller 36. For example, a layer of elastomer may be formed or bonded to the cylindrical body 52 to provide a high friction surface. Consequently, the drive roller 36 may engage an object to be moved, the floor beneath and/or another rolling element without slippage.

Referring again to FIG. 3, the forward support roller 32 is mounted over and supported by bearings 72 which accept an axle 74. The axle 74 defines the rotational axis 32A of the forward roller 72 and engages apertures 76 within the sideplates 16a, 16b of the chassis 12. In the preferred embodiment, the axle 74 mounts to the chassis by C-rings 78 to facilitate removal, replacement and/or substitution of the forward roller 32 with other elements/components (e.g., a pusher plate discussed in greater detail hereinafter).

The forward support roller 32 is mounted to the chassis 12 and adjacent to the drive roller 36 such that the exterior surfaces of the rollers 32, 36 are contiguous. Consequently, in operation, the forward roller 32 is driven by the drive roller 36 through frictional engagement of the rollers 32, 36. Similar to the drive roller 36, the forward roller 32 preferably employs a high friction surface for improving the efficacy of the friction drive. Moreover, inasmuch as the forward support roller 32, in the most frequently used configuration, propels and supports the power-handling device 10 along the floor, a herringbone tread is formed on the surface of the roller 32. Finally, to ensure that the rollers 32, 36 remain in contact during operation and, over time, as wear may alter the diameter dimensions of the rollers 32, 36, the apertures 76 (see FIG. 2b) may be vertically elongated to permit a small degree of roller displacement. That is, under the load of a heavy object, the forward support roller 32 may be displaced and urged into engagement with the drive roller 36 should wear otherwise separate the rollers 32, 36.

As described hereinbefore, the motor 50 is disposed internally of the drive roller 36 and affixed to the chassis 12 by the cylindrical support 40. While the motor 50 is mounted to the cylindrical support 40 at a forward location (i.e., at the output shaft end 50e thereof) any one of a variety of means may be employed for reacting motor torque and/or preventing motor rotation. For example, the motor housing may be polygonally-shaped for engaging a similarly shaped aperture of the chassis thereby effecting mechanical interlock for anti-rotation.

In the preferred embodiment, the motor 50 delivers high torque to the drive roller 36 and may be powered by any of a variety of known power sources. In the described embodiment, the motor 50 is pneumatically powered driven and is of the type produced by Atlas Copco, a US Manufacturer. The motor is capable of delivering high torque when supplied with a working pressure of 600 to 700 kPA.

Still referring to FIG. 3, pneumatic power is delivered to the motor 50 via tubing 80 disposed internally of the chassis 12 and, more specifically, in fluid communication with air passageways formed in the aft handling section 12_{AH}. A variety of methods may be employed for supplying the motor 50 with pressurized air, although, as will be described in greater detail below, the present invention employs plumbing schemes which mast or obscure the tubing 80/passageways. As such, the power handling device 10 remains compact, versatile and aesthetically pleasing.

A pair of conventional wheels 34 are journally mounted to stub axles 82 projecting outwardly of each sideplate 16a, 16b. Furthermore, the cross member 18c disposed between the sideplates 16a, 16b defines an internal passageway which is in fluid communication with the tubing 80 for supplying pressurized air to the motor 50. More specifically, the handle shaft 90 is disposed in combination with the cross member 18c and provides a conduit for pressurized air to be delivered to an internal chamber 84 of the cross member 18c. In one embodiment of the invention, the cross member 18c defines an inlet aperture 18I and an outlet fitting 18E. The handle shaft 90 is rigidly affixed, e.g., welded to the cross member 18c, and aligned with the inlet aperture 18I such that pressurized air PA may flow from the tubular shaft 90 to the internal chamber 84 of the cross member 18c. Furthermore, the outlet fitting 18E is coupled to the tubing 80 to complete the air supply line from the handle shaft 90 to the motor 50.

As previously mentioned, the chassis 12 is preferably bifurcated by means of a separation or split in each of the sideplates 16a, 16b between the drive roller 36 and the pair of aft wheels 34. More specifically, the sideplates 16a, 16b are configured to define lap joints 100a, 100b which are substantially symmetric. Furthermore, the lap joints 100a, 100b and the outlet fitting 18E are designed to facilitate ease of assembly and disassembly. For example, the lap joints 100a, 100b are readily assembled by means of a wrench or ratchet (not shown) and the outlet fitting 18E may employ a quick disconnect coupling (also not shown).

Before discussing yet other embodiments of the invention, it will be useful to discuss the scope of several teachings of the invention in addition to various structural and functional advantages of the specific embodiment(s) described above.

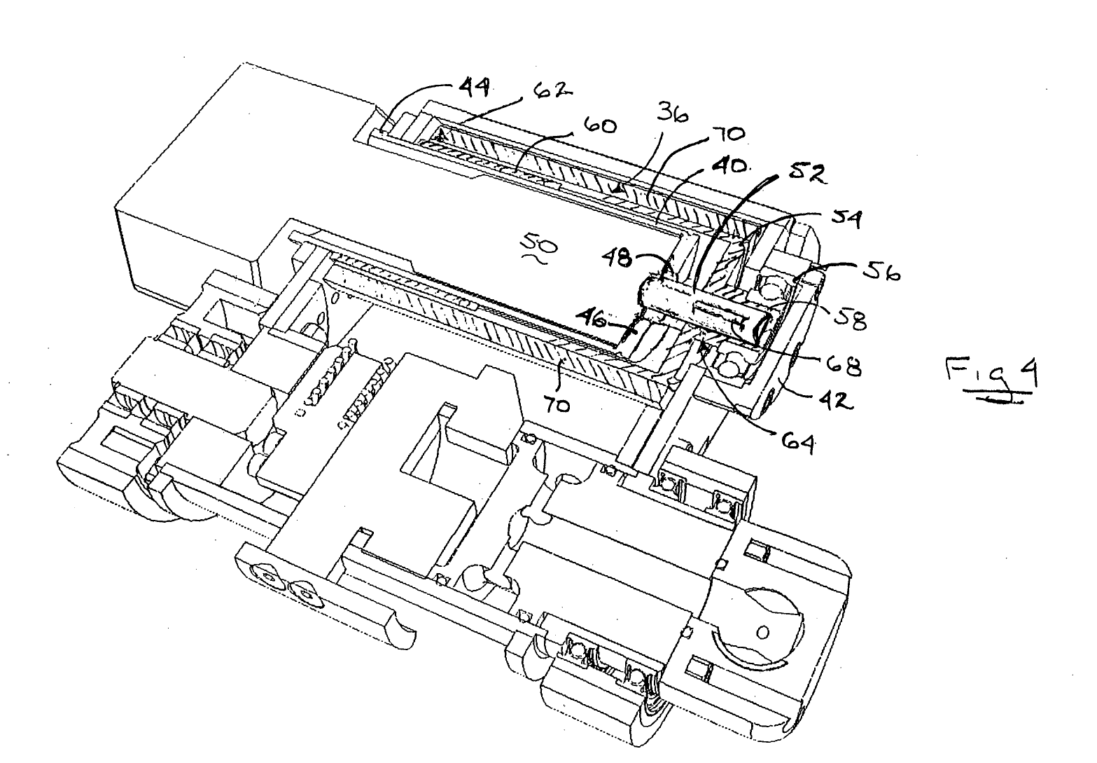

The power handling device 10 of the present invention is uniquely packaged and arranged to provide optimum versatility and maximum utility. To best appreciate the scope and utility of the invention, it is useful to examine certain geometric characteristics of the power handling device 10. In FIGS. 5a and 5b, two dimensional projections of the power handling device 10 defines clearance planes for establishing/bounding the location of various components and, in particular, components associated with the propulsion of the device 10. More specifically, the clearance planes, in combination, define a Non-Interference Envelope NIE shown as straight lines CL₁₀ (an edgewise view of each plane) intersecting points 30_{T} tangent to a circle outlining the circumference of each of the rolling elements 30. The tangency points 30_{T} of one rolling element relative to an adjacent rolling element lie on the same side of a line L_{C} intersecting the centers 30_{C} of each of the rolling elements 30. Moreover, the NIE is driven by clearance requirements of the power handling device 10 between the chassis 12 and the floor G_{F} and between the chassis 12 and the object (not shown). It will be appreciated that in the configuration shown in FIG. 5a, the NIE is defined by the lines CL₁₀ which intersect to form an acute angle θ₁ forward of the support roller 32. In the configuration shown in FIG. 5b, wherein the forward propulsion section 12_{FP} has been reversed to its “bottoms-up” orientation relative to the aft handling section 12_{AH}, the NIE is defined by the lines CL₁₀ which intersect to form an acute angle θ₂ aft of the wheels 34.

The invention requires that all elements in connection with the propulsion of the power handling device 10, e.g., the motor 50, tubing 80, torque reaction means, and cylindrical motor mount 40 etc., lie within the boundaries established by the NE. In accordance with this teaching, the drive roller 36 circumscribes the motor 50 and the tubing 80 is disposed internally of the chassis 12, thereby mounting these components within the NIE.

When employing this teaching, the power handling device 10 may be reversed, re-oriented and/or reconfigured to operate on at least two pairs of rolling elements 30. Referring collectively to FIGS. 3-5b, in a first orientation (most appropriately illustrated in FIG. 5a), the power handling device 10 is supported and propelled by the forward roller 32 and aft pair of wheels 34. In this configuration, the drive roller 36 is disposed at the apex of the triangle defined by the roller geometry (discussed previously). Furthermore, the drive roller 36 simultaneously drives the forward roller 32 while effecting the rotation of an object. That is, the forward roller 32 propels the power handling device 10 forwardly while the drive roller 36 rotates the object to propel it in the same direction.

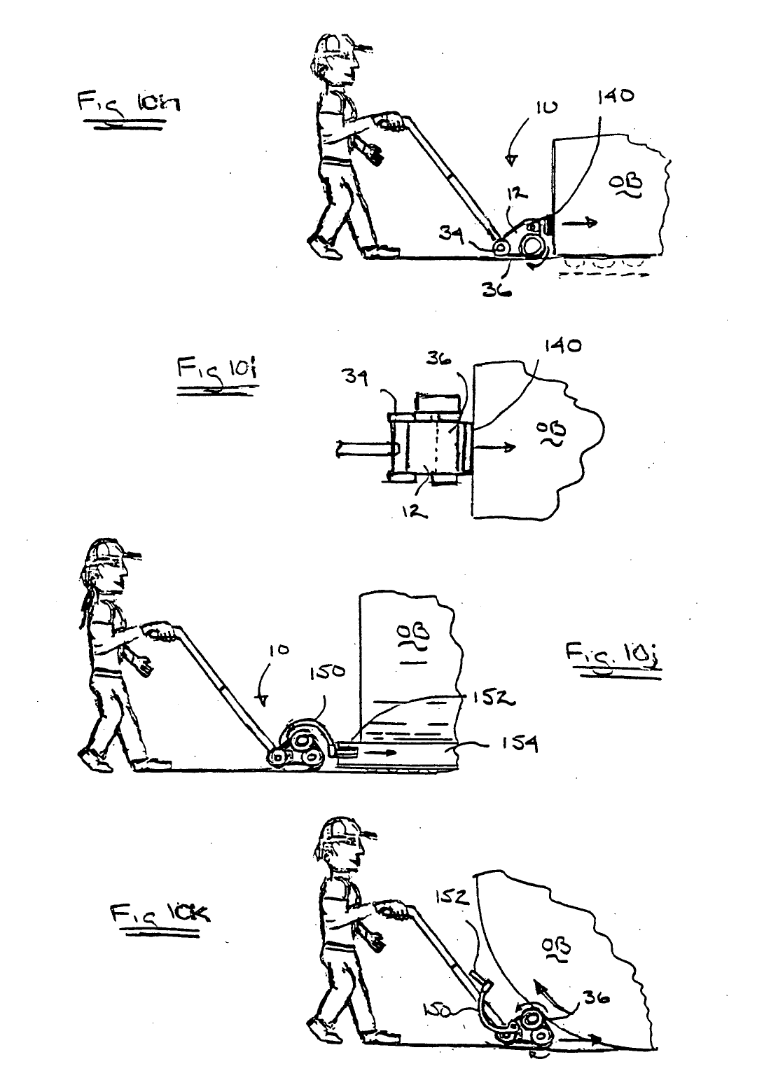

In a second orientation (most appropriately illustrated in FIG. 5b), the drive roller 36 and the aft pair of wheels 34 support and propel the power handling device 10. Furthermore, it will be appreciated that the forward roller 32 is now disposed at the apex of the triangular roller geometry and forward of the drive roller 36. Rather than propelling the device 10, the forward roller 32 engages the object to effect its rotation and forward motion. The drive roller 36, in contrast to its function in the previous orientation, engages the underlying floor G_{L} to propel the power handling device 10. Both of the prior two configurations will be described in greater detail (including illustrations) when describing all of the various configurations/operations of the power handling device in FIGS. 10a-10k.

It will also be appreciated that the handle shaft 90 must be reconfigured to function in both modes of operation. To maintain the substantially upright position and attitude of the handle shaft 90, the aft handling section 12_{AH} is detached from the forward propulsion section 12_{FP} and rotated 180 degrees relative to a forwardly-facing horizontal axis LA (see FIG. 3). This modification is enabled by the separation of the chassis 12 via the lap joints 100a, 100b and a disconnect fitting within the line of the tubing 80.

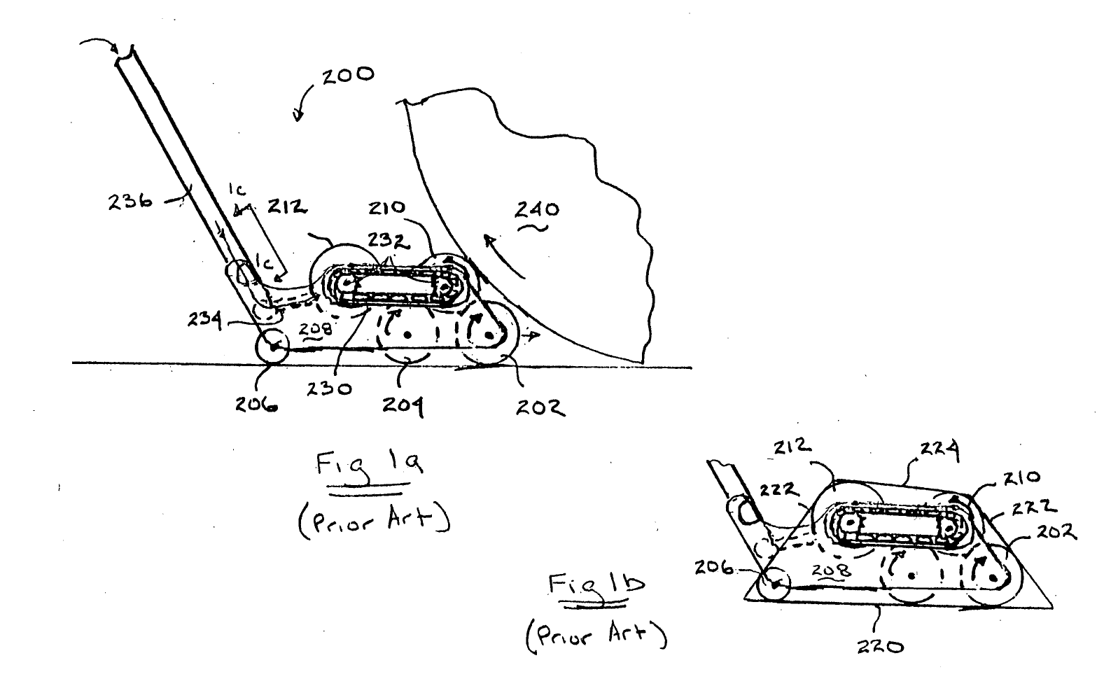

In view of the foregoing, the power handling device 10 of the present invention may be supported by at least two pairs of the rolling elements 30, (e.g., the forward support roller 32 in combination with the aft wheels 34, and the aft wheels 34 in combination with the drive roller 36) without interfering with other components or requiring use thereof in an ergonomically incorrect position. By way of comparison, the prior art drive device 200 shown in FIG. 1b defines a trapezoidal shape wherein the motor 212 and chain link drive 230 lie outside or beyond the NIE required by the teachings of the present invention. Consequently, the prior art device 200 is not reversible or capable of operation on more than two rolling elements.

Furthermore, location of the motor 50 within the drive roller 36 permits a direct torque drive from the output drive shaft 52 of the motor 50 and the drive roller 36. As such, high maintenance components such as the chain link drive 230 of the prior art may be eliminated. Consequently, the maintenance requirements of the power handling device 10 are reduced while improving reliability.

The power handling device 10 is, furthermore, capable of being pivoted about the aft rotational axis 34A to raise the forward propulsion section 12_{FP} out of contact with the underlying floor in a manner similar to a hand-cart. Here again, the compact design of the power handling device 10 effects a short or small moment arm between the chassis center of gravity (C.G.) and the rotational axis 34A, thus minimizing the handle torque and torsional stresses at the point of handle-chassis connection. This pivoting capability greatly improves the maneuverability of the power handling device 10.

Additionally, bifurcation of the power handling device into forward propulsion and aft handling sections 12_{FP}, 12_{AH} permits extensive reconfiguration and modularity of the device 10. For example, a forward propulsion section having greater power output, larger drive and forward support rollers, or other geometric modifications may be employed while using the same aft handling section 12_{AH}. Furthermore, by designing identical and symmetrical lap joints 100a, 100b, the aft handling section 12_{AH} may be rotated to change the position of the handle shaft 90 relative to the chassis 12 and with respect to the subject object or article being move/manipulated.

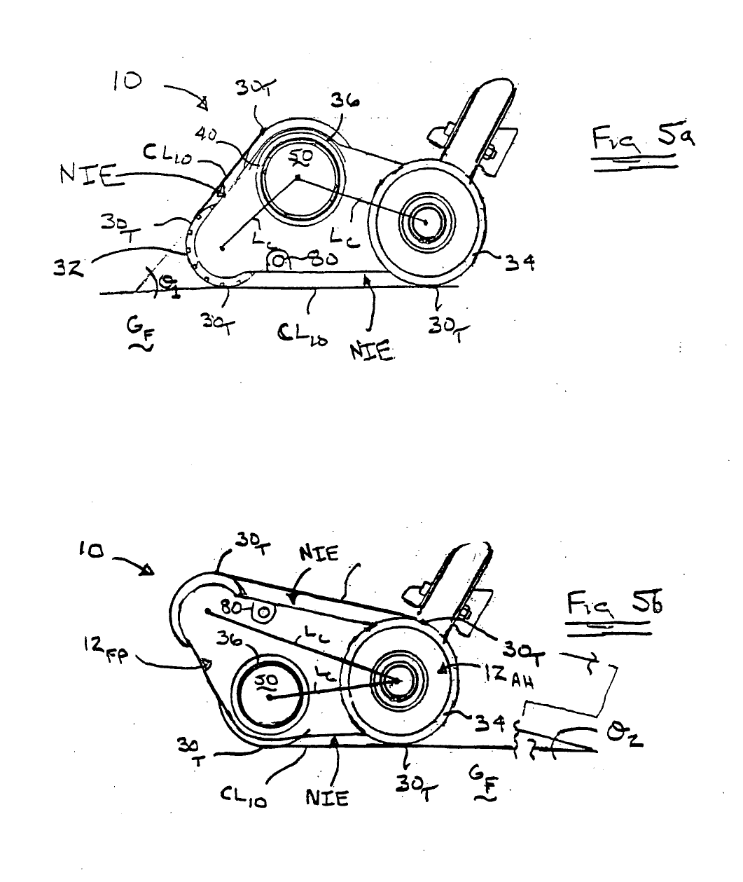

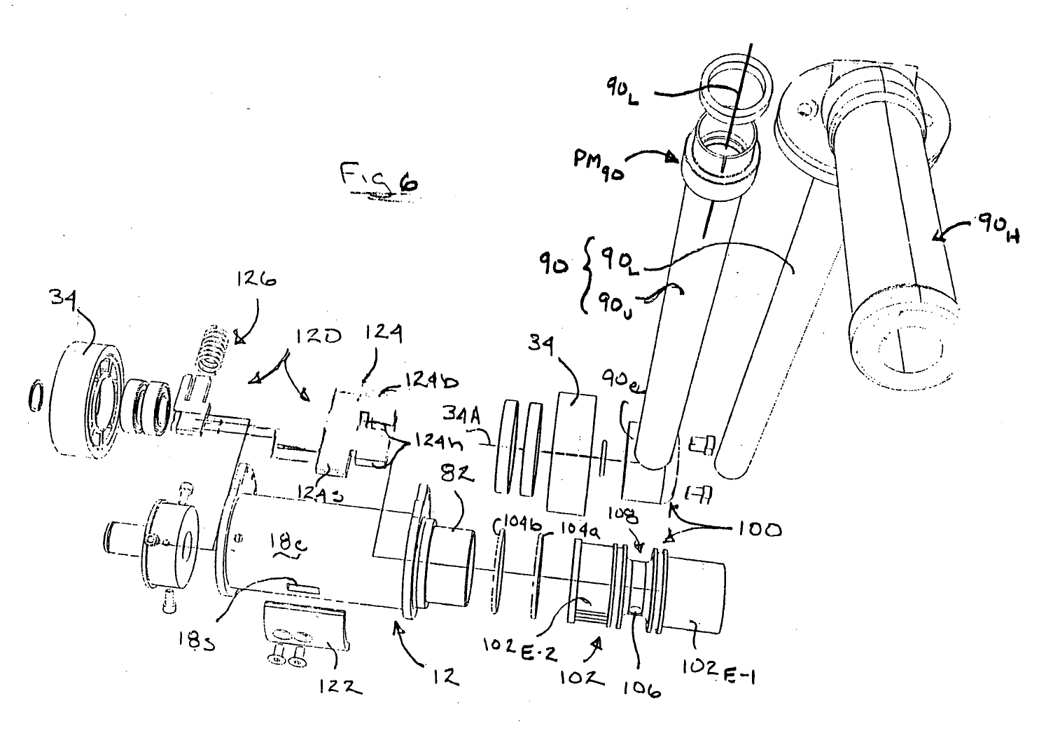

In another embodiment of the invention and referring to FIGS. 6 and 7, the handle shaft 90 (not shown in FIG. 7) is pivotally mounted to one side of the chassis 12, i.e., right or left, about the rotational axis 34A of the aft pair of wheels 34. More specifically, a pivot mounting means 100 couples the handle shaft 90 to the chassis and a locking mechanism 120, disposed in combination with the mounting means 100, functions to lock the angular position of the handle shaft 90 relative to the chassis 12. In the preferred embodiment, the pivot mounting means 100 comprises a spool fitting 102 disposed internally of one stub axle 82 of the chassis 12. In the described embodiment, the cross member 18c of the aft handling section is substantially cylindrical in shape and provides support and mounting surfaces/apertures for the pivot mounting means 100 and locking mechanism 120. It will be appreciated, however, that the cross member 18c may take a variety of shapes while maintaining the functionality or operation of the various aft handling section components.

The spool fitting 102 includes a first cylindrical end 102_{E-1} which engages an end cap 90e of the handle shaft 90 and a second cylindrical end 102_{E-2} for engaging a double J-shaped locking plate of the locking mechanism 120. Furthermore, the spool fitting 102 includes ring seals 104a, 104b disposed about the periphery of the spool fitting 102, which ring seals 104a, 104b provide an airtight seal against the internal surface of the stub axle 82. Furthermore, the seals 104a, 104b permit rotation of the spool 102 about the rotational axis 34A. The spool fitting 102 also defines a central aperture 106 (best seen in FIG. 7) and a circumferential groove 108 for providing a fluid communication passageway for pressurized air to flow from the handle shaft 90 to the external coupling of the chassis 12. As such, the handle shaft 90 is free to rotate or pivot about the rotational axis 34A while providing an airtight passageway for pressurized air (the air that powers the motor 50).

The locking mechanism 120 comprises a kick-plate 122 disposed externally of the rear cross member 18c, a double J-shaped locking plate 124 for engaging the spool fitting 102 of the pivot mount 100 and spring bias means 126 for causing the locking plate 124 to engage and disengage the spool fitting 102 in response to radial motion of the handle shaft 90. More specifically, the locking plate 124 is disposed substantially horizontally (in the orientation shown) and extends across the diameter of the cylindrically shaped cross member 18c. The locking plate 124 furthermore, includes an upper stem 124s for mounting to the kick-plate 122 (i.e., extending through a wall of the cylindrical cross member), a base portion 124b extending through and supported by a longitudinal slot 18s of the cross member 18c, and a pair of J-hooks 124h which engage longitudinal slots 102s of the spool fitting 102. Finally, the locking plate 124 is disposed in combination with the spring bias means 126 for biasing the J-hooks 124h into engagement with the slots 102s of the spool fitting 102e. The spring bias means 126 may be any of a variety of known devices, although the present invention employs a coil spring 130 disposed about and supported by a guided plunger 132 which is affixed to the stem 124s of the locking plate 124.

In operation, the kick-plate 122 is urged inwardly against a counteracting force provided by the spring bias means 126. The locking plate 102 and, more specifically, the J-hooks thereof, is displaced causing the J-hooks 102h to disengage the longitudinal slots 102s of the spool fitting 102. As such, the handle shaft 90 is released and may be repositioned by rotating the shaft 90 through a predetermined angle. When the shaft 90 rotates through an angle which causes the J-hooks to once again align with the longitudinal slots 102s, the spring bias means 126 will again cause the locking plate 102 and the J-hooks 102h thereof to engage the slots 102s. Consequently, the handle shaft 90 is caused to rotate 180 degrees from its initial position and locked. While only two angular positions are depicted in the described embodiment, it will be appreciated that the spool fitting 102 may contain multiple slots 102s disposed about its circumference, thereby enabling the handle shaft 90 to assume a multiplicity of angular positions.

To improve the ergonomic position of the handle 90H, the handle shaft 90 may comprise upper and lower shaft segments 90U and 90L, respectively. These segments 90U, 90L are joined by a coupling PM₉₀ which enables relative rotation about the longitudinal axis of the 90L of the handle shaft 90. Moreover, the coupling PM₉₀ may also permit the segments to telescope. As such, the handle 90H may be rotated or telescoped to the correct ergonomic position and/or height. The telescoping feature may also facilitate storage in confined areas or shipping in small containers.

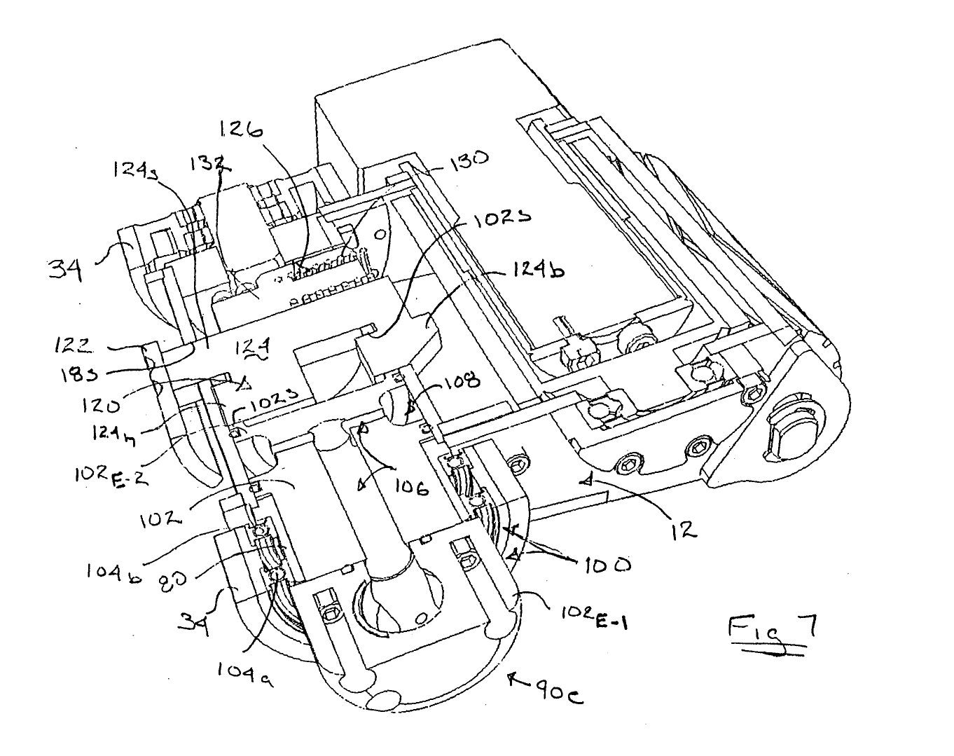

In another embodiment of the invention shown in FIG. 8, the power handling device 10 is reconfigured to push and/or pull an object rather than rolling the object as previously described. In the embodiment illustrated, a push/pull fitting 140 is adapted for mounting to the chassis 12 by detachably mounting the forward roller. More specifically, the forward roller is detached from the chassis 12 such that the push/pull fitting 140 may take its place and mount to the same apertures 76. To be used in this configuration, the power handling device 10 must be turned-over or reversed such that the drive roller 36 and aft pair of wheels 34 support the chassis 12. Furthermore, the handle shaft 90 must be repositioned to assume an up-right position. In operation, the drive roller 36 propels the unit (along the floor or ground) while an abutment surface of the fitting 140 engages an object to be moved. In view of the forgoing, it will be appreciated that the forward propulsion section 12_{FP} can be configured with a forward roller 36 i.e., if its primary use will be to roll loads, or with the push fitting 140 i.e., if its primary use will be to push loads.

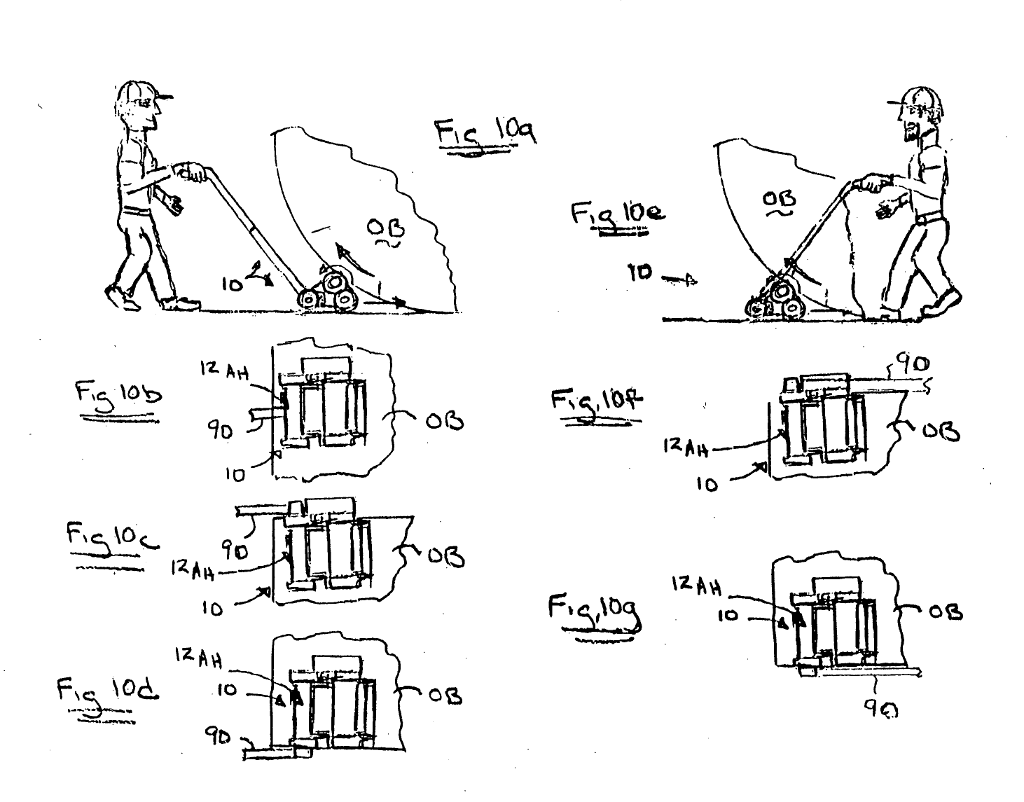

In another embodiment, the power-handling device 10 need not be reversed or reconfigured. In this embodiment, shown in FIG. 9, a repositionable fitting 150 is pivot mounted to an upper portion of the chassis 12, and preferably mounted aft of the drive roller 36. More specifically, the fitting 150 may be rotated to a frontal position, in advance of the forward roller (obscured by the fitting 150) such that abutment surfaces may push an object forward. The illustrated embodiment optionally employs a pair of forwardly projecting forks 152 for being disposed under a cylindrical object having its rotational axis 90 degrees from the direction of forward motion. That is, the forks 152 lie below the cylindrical object and engage a rolling dolly (not shown) to steady the power handling device 10 relative to the dolly. An advantageous feature of this embodiment is the ability to use the fitting 150 in a first operational mode to push an object while also having the ability to stow the fitting 150 in a second operational mode wherein the power handling device 10 engages and propels the object by rotation of the drive roller 36. It is for this reason that the fitting 150 is most preferably pivotally mounted aft of the drive roller 36 to prevent interference when using the device 10 in the second operational mode.

In yet another embodiment of the invention, the power handling device 10 may be portable and includes a dedicated power supply which is disposed internally of the chassis. More specifically, the power handling device 10 may include a rechargeable energy source (not shown), e.g., a rechargeable battery, and a means for recharging the energy source, e.g., a docking station (also not shown). The battery may be disposed in combination with either the forward propulsion or aft handling sections 12_{FP}, 12_{AH}. When being mounted in combination with the forward propulsion section 12_{FP}, the battery will necessarily lie with the bounds of the Non-Interference Envelope NIE (similar to the teaching involving the motor and other propulsion system components). When mounted in combination with the aft handling section 12_{AH}, the battery will mount to the chassis 12 forward of the aft wheels 34. In this configuration, rearward propulsion of an object is not possible, hence the power handling device 10 will necessarily be dedicated to “forward propulsion”.

Furthermore, the weight of the battery should lie proximal to the rotational axis 34A about which the power handling device 50 is pivoted for prepositioning. As such, a short moment arm is effected between the battery the Center of Gravity (C.G.) and the axis 34A, and the force required to pivot the device 10 is minimized.

The docking station interfaces with and recharges the power handling device 10 via the aft handling section 12_{AH}, but may interface by any of a variety of means. In the preferred embodiment, the handle shaft 90 is repositioned to assume a substantially vertical orientation for space efficiency and to minimize any likelihood (albeit small) that the power handling device 10 will cause an accident or injury.

The features described in connection with the pneumatically powered handling device are essentially identical for the electrically powered device, although certain structure such as the cross members may be modified to accommodate the size and/or weight of the power source.

In FIGS. 10a-10f, various configurations and applications of the power handling device 10 are depicted. In FIG. 11a, the power handling device 10 is configured for use in moving large multi-ton cylindrical objects OB in a forward direction. Therein, the forward roller 32 propels and supports, in conjunction with the aft pair of wheels 34, the power handling device 10. At this same time, the drive roller 36 engages the cylindrical object OB to effect its rotation and forward movement. With regard to this application (in addition to many of the other applications described below), a suitable triangular profile is chosen to ensure that the cylindrical object OB clears or does not interfere with the chassis 12 or other elements of the forward propulsion section 12_{FP} e.g., the forward roller 32. Either version of the aft handling section 12_{AH} may be employed, e.g., fixed or pivotable handle shafts 90. In FIG. 11b, the fixed handle shaft 90 is shown beneath the object OB and, in FIGS. 11c and 11d the pivotable handle shaft 90 is illustrated for right or left hand access to the object OB.

In FIG. 11e, the power handling device 10 is employed to drive an object in a reverse direction. In this application, the handle shaft 90 has been rotated 180 degrees relative to the position assumed in the previous application. Therein, the drive roller 36 engages the cylindrical object OB to effect its rotation and rearward motion. Again, a suitable triangular profile is chosen to ensure that the cylindrical object OB clears or does not interfere with the chassis 12 or other components of the device 10, e.g., aft handling section 12_{AH}. In this configuration, only the pivoting version (i.e., handle shaft 90) of the aft handling section 12_{AH} may be employed. FIGS. 11f and 11g depict the use of the power handling device 10 from either side of the object OB.

In FIGS. 11h-11k, the power handling device 10 is used to push/pull an object OB. Generally, these configurations will be employed to push an object, however, with certain minor alterations or additions, e.g., rope or cable attached to a fitting, the power handling device 10 may be employed to also pull an object. More specifically and referring to FIGS. 11h and 11i, the device 10 is reversed or turned-over such that the drive roller 36 in combination with the aft wheels 34 supports the power handling device 10. The forward roller, which mounts to apertures of the chassis 12 by quick-disconnect C-clips, is removed and the push/pull fitting 140 installed in its place (using the same mounting apertures). As such, the drive roller 36 propels the device, either forward or backward, depending upon the orientation of the chassis 12, and the push/pull fitting 140 either directly or indirectly (i.e., via rope, cable etc.) engages to push or pull the object OB. While the object OB is shown sliding on the floor, the more common application will be for the object to sit on rollers or a guiding track (not shown).

In FIG. 11j, the power handling device 10 is shown with the repositionable fitting 150 pivot mounted to the upper portion of the chassis 12. As discussed earlier with reference to FIG. 9, the fitting 150 may be rotated to a frontal position, in advance of the forward roller 32 to push an object OB forward. The illustrated embodiment optionally employs a pair of forwardly projecting forks 152 for being disposed under a cylindrical object having its rotational axis 90 degrees from a direction of forward rolling motion. That is, the forks 152 lie below the cylindrical object and engage a rolling dolly 154 to steady the power handling device 10 relative to the dolly 154. Yet another way to use the forks 152 includes pivoting the power handling device about the forward support roller 32 such that the forks 152 are wedged under the object. While this application is not illustrated, one can readily envision that the aft wheels may be raised slightly (not in contact with the floor), while the forward support roller propels the object OB forward.

In FIG. 11k, the fitting 150 is stowed such that the power handling device 10 may be used in one of its more conventional configurations, i.e., one which employs the use of the drive roller 36 to rotate a cylindrical or circular object OB.

Although the invention has been described in terms of its various embodiments, one will appreciate that the teachings of the invention provide for various other embodiments which fall within the spirit and scope of the invention.

1) A power handling device having a chassis supporting at least two rolling elements, a handle shaft mounting to the chassis, a motor for driving at least one of said rolling elements, and a power supply for energizing said motor, each of the rolling elements rotating about a rotational axis, said power handling device characterized by:
a Non-Interference Envelope (NIE) defined by straight lines intersecting outermost points of tangency on at least two of said rolling elements, said motor lying within said NIE.

2) The power handling device according to claim 1
wherein at least one of said rolling elements circumscribes and is driven by said motor.

3) The power handling device according to claim 2
wherein said motor includes an output drive shaft;
wherein said drive roller is co-axial with said output drive shaft, and
is further characterized by:
a torque drive means for directly driving said drive roller about said rotational axis thereof.

4) The power handling device according to claim 3
wherein said chassis includes a cylindrical support having an end defining an inwardly facing flange and a central aperture;
wherein said motor is affixed to said flange and disposed internally of said cylindrical support;
wherein said drive roller circumscribes said cylindrical support, and
wherein said output drive shaft extends through said aperture and directly drives an end of said drive roller about said rotational axis.

5) The power handling device according to claim 1
wherein said rolling elements comprise at least three rolling elements defining a substantially triangular profile, and
means for reconfiguring chassis to enable support by at least two pairs of said rolling elements.

6) The power handling device according to claim 5
wherein said at least three rolling elements comprise a drive roller, a forward roller and a pair of aft wheels, said drive roller being disposed at the apex of said triangular profile and interposed between said forward roller and pair of aft wheels, and
wherein said chassis is separated to define a forward propulsion section and an aft handling section, and
said reconfiguration means being further characterized by:
a detachment means disposed between said drive roller and another of said rolling elements to facilitate separation and attachment of said forward propulsion section and said aft handling section.

7) The power handling device according to claim 5 further characterized by:
means for pivotally mounting said handle shaft to said chassis, said pivot mounting means effecting rotation of said handle shaft about said rotational axis of said pair of aft wheels, and
means for repositioning said handle shaft relative to said chassis to vary the angular orientation of said handle shaft.

8) The power handling device according to claim 5
further characterized by
a push/pull fitting disposed in combination with said chassis.

9) The power handling device according to claim 5
wherein said forward roller is detachably mounted within forward apertures of said chassis; and
wherein said push/pull fitting is mounted to said forward apertures to provide an abutment surface in an operational mode requiring an object to be linearly pushed/pulled.

10) A power handling device having a chassis supporting a plurality of rolling elements, a handle shaft mounting to the chassis, a motor for driving at least one of said rolling elements, and a power supply for energizing said motor, each of the rolling elements rotating about a rotational axis, said power handling device characterized by:
said rolling elements comprising at least three rolling elements defining a substantially triangular profile, and
means for reconfiguring said chassis to enable support by at least two pairs of rolling elements.

11) The power handling device according to claim 10
wherein said at least three rolling elements comprise a drive roller, a forward roller and a pair of aft wheels, said drive roller being disposed at the apex of said triangular profile and interposed between said forward roller and pair of aft wheels, and
wherein said chassis is bifurcated to define a forward propulsion section and an aft handling section, and
said reconfiguration means is further characterized by:
a detachment means disposed between said drive roller and another of said rolling elements to facilitate separation and attachment of said forward propulsion section and said aft handling section.

12) The power handling device according to claim 10 further characterized by:
means for pivotally mounting said handle shaft to said chassis, said pivot mounting means effecting rotation of said handle shaft about said rotational axis of said pair of aft wheels, and
means for repositioning said handle shaft relative to said chassis to vary the angular orientation of said handle shaft.

13) The power handling device according to claim 10 further characterized by
a push/pull fitting disposed in combination with said chassis.

14) The power handling device according to claim 10
wherein said forward roller is detachably mounted within forward apertures of said chassis; and
wherein said push/pull fitting is mounted to said forward apertures to provide an abutment surface in an operational mode requiring said object to be linearly pushed/pulled.

15) The power handling device according to claim 10
wherein at least one of said rolling elements circumscribes and is driven by said motor.

16) The power handling device according to claim 15
wherein said motor includes an output drive shaft;
wherein said drive roller is co-axial with said output drive shaft, and
is further characterized by:
a torque drive means for directly driving said drive roller about said rotational axis thereof.

17) The power handling device according to claim 16
wherein said chassis includes a cylindrical support having an end defining an inwardly facing flange and a central aperture;
wherein said motor is affixed to said flange and disposed internally of said cylindrical support;
wherein said drive roller circumscribes said cylindrical support, and
wherein said output drive shaft extends through said aperture and directly drives an end of said drive roller about said rotational axis.

18) A power handling device for manipulating heavy objects, said power handling device having a chassis supporting a plurality of rolling elements, a handle shaft mounting to the chassis, a motor for driving at least one of said rolling elements, said power handling device characterized by:
a push/pull fitting pivotally mounted to said chassis and having an abutment surface disposed forward of the chassis such that in one operational mode the fitting is pivoted to a forward position and said abutment surface propels the object and
in another operational mode the fitting is pivoted to a reward stowed position such that the drive roller engages and propels the object.
docking station means for recharging said power source.

19) The power handling device according to claim 18
wherein said rolling elements comprise a forward support roller, an aft pair of wheels and a drive roller disposed therebetween, said rolling elements defining a substantially triangular profile, and
wherein said fitting is a pivotally mounted aft of said drive roller.

20) The power handling device according to claim 19
wherein said drive roller circumscribes and is driven by said motor.
